(19) United States
(12) Patent Application Publication
(10) Pub. No.: US 2026/0370959 A1
(43) Pub. Date: Nov. 19, 2026

(54) IMAGING DEVICE

(71) Applicant: Panasonic Intellectual Property Management Co., Ltd., Osaka (JP)

(72) Inventor: Yasuhiro SHINGU, Osaka (JP)

(73) Assignee: Panasonic Intellectual Property Management Co., Ltd., Osaka (JP)

(21) Appl. No.: 19/132,041

(22) PCT Filed: Jun. 26, 2023
(86) PCT No.: PCT/JP2023/023612

§ 371 Date: May 22, 2025

(30) Foreign Application Priority Data
Nov. 25, 2022 (JP) 2022-188565

(51) Int. Cl. H04N 23/81; H04N 23/63

(52) U.S. Cl. CPC H04N 23/81; H04N 23/632

(57) ABSTRACT

A digital camera is provided with an imaging element that receives light incident through an optical system including at least one lens to generate a digital image. The digital camera is further provided with a wireless communication unit that communicates with an image correction apparatus, the image correction apparatus correcting the digital image using a correction program for correcting images based on individual characteristic information indicating an optical characteristic specific to the digital camera. The wireless communication unit transmits the digital image generated by the imaging element, and identification information of the digital camera, to the image correction apparatus.

### TECHNICAL FIELD

The present disclosure relates to an imaging apparatus, an imaging method, and a program.

### BACKGROUND ART

An imaging apparatus, such as a digital camera, may produce undesirable distortion and unevenness in a captured digital image (still image) or digital moving image, due to design or manufacturing variations. Therefore, the imaging apparatus may be provided with a correction circuit or a correction program for correcting images based on specific optical characteristics measured during or after manufacture.

Patent Document 1 discloses a digital camera in which a value relating to a backlash is measured at the time of manufacturing the digital camera and is stored in an internal flash memory, and before normal lens driving, the focus lens is moved in the forward direction so that the backlash is corrected.

### CITATION LIST

### Patent Documents

PATENT DOCUMENT 1: Japanese Patent Laid-open Publication No. JP 2011-085928 A

### SUMMARY OF INVENTION

### Technical Problem

In order to provide the imaging apparatus with the correction circuit or the correction program, the circuit size and cost of the imaging apparatus increase. In addition, in order to correct an image based on optical characteristics specific to a certain imaging apparatus, it is necessary to provide the imaging apparatus with a mass and nonvolatile storage device to store information indicating the optical characteristics, and therefore, the circuit size and cost of the imaging apparatus increase. In addition, in order to operate the correction circuit or to execute the correction program, much power is consumed every time an image is captured. Therefore, it is required to reduce the circuit size, cost, and/or power consumption of the imaging apparatus as compared with the prior art.

An object of the present disclosure is to provide an imaging apparatus, an imaging method, and a program capable of correcting undesirable distortion, unevenness, and others in a captured digital image, while reducing a circuit size, cost, and power consumption as compared with the prior art.

### Solution to Problem

An image correction apparatus according to one aspect of the present disclosure is provided with: a communication unit, a storage unit, and a processing unit. The communication unit receives a digital image captured by an imaging apparatus, and identification information of the imaging apparatus. The storage unit stores a correction program for correcting images. The processing unit obtains individual characteristic information based on the identification information, the individual characteristic information indicating an optical characteristic specific to the imaging apparatus, and corrects the digital image using the correction program based on the individual characteristic information.

### Advantageous Effects of Invention

The imaging apparatus according to one aspect of the present disclosure can correct undesirable distortion, unevenness, and others in a captured digital image, while reducing a circuit size, cost, and power consumption as compared with the prior art.

### BRIEF DESCRIPTION OF DRAWINGS

FIG. 1 is a block diagram showing a configuration of an image correction system 20 according to a first embodiment.

FIG. 2 is a block diagram showing a configuration of a digital camera 1 of FIG. 1.

FIG. 3 is a block diagram showing a configuration of an image correction apparatus 2 of FIG. 1.

FIG. 4 is a block diagram showing a configuration of server apparatuses 3-1 to 3-3 and 4 to 6 of FIG. 1.

FIG. 5 is a block diagram showing a configuration of user terminal apparatuses 7 and 8 of FIG. 1.

FIG. 6 is a block diagram showing an arrangement for obtaining individual characteristic information of a camera body 100 of FIG. 2 through measurement, and providing the individual characteristic information to the server apparatus 3-1 of FIG. 1.

FIG. 7 is a block diagram showing an arrangement for obtaining individual characteristic information of a lens apparatus 200 of FIG. 2 through measurement, and providing the individual characteristic information to the server apparatus 3-2 of FIG. 1.

FIG. 8 is a sequence diagram showing initial communication between the camera body 100 and the lens apparatus 200, immediately after the digital camera 1 of FIG. 2 is powered on.

FIG. 9 is a sequence diagram showing normal communication between the camera body 100 and the lens apparatus 200, when the digital camera 1 of FIG. 2 captures an image.

FIG. 10 is a sequence diagram for the image correction system 20 of FIG. 1, showing a correction process in which the image correction apparatus 2 corrects an image captured by the digital camera 1.

FIG. 11 is a sequence diagram for the image correction system 20 of FIG. 1, showing a correction process in which the image correction apparatus 2 corrects a preview image to be displayed on the digital camera 1.

FIG. 12 is a sequence diagram for the image correction system 20 of FIG. 1, showing a correction process to be performed, when a correction program is updated, on an image having been temporarily stored in the server apparatus 5.

FIG. 13 is a diagram showing a table to be displayed on a display unit of the digital camera 1 or the user terminal apparatus 7, in a case where the image correction apparatus 2 of FIG. 1 stores multiple versions of a correction program.

FIG. 14 is a block diagram showing a configuration of a digital camera 1A according to a second embodiment.

### DESCRIPTION OF EMBODIMENTS

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art.

It is to be noted that the inventor(s) intends to provide the accompanying drawings and the following description so that those skilled in the art can sufficiently understand the present disclosure, and does not intend to limit subject matters recited in the claims.

### First Embodiment

In the following, a first embodiment of the present disclosure will be described.

### [Configuration of Image Correction System]

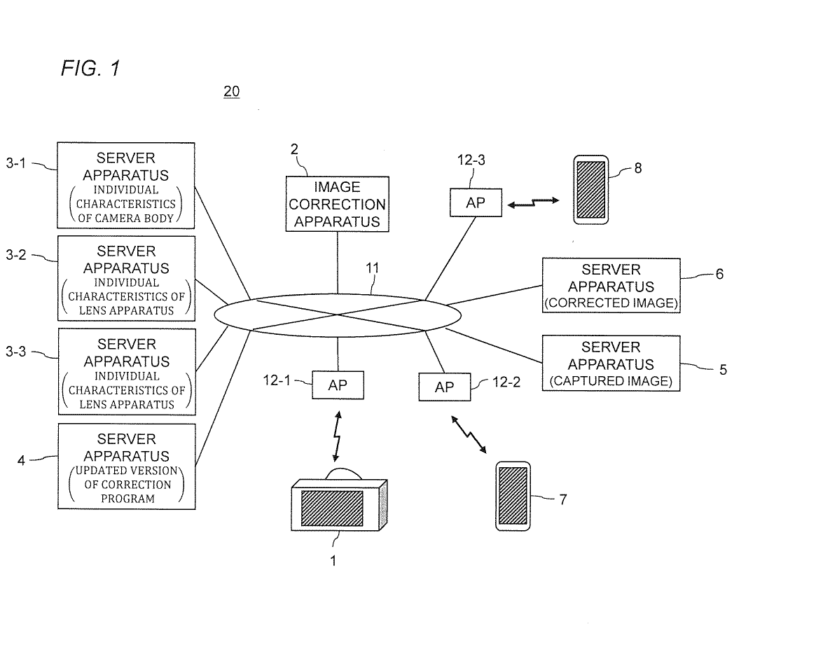

FIG. 1 is a block diagram showing a configuration of an image correction system 20 according to a first embodiment. The image correction system 20 is provided with a digital camera 1, an image correction apparatus 2, a plurality of server apparatuses 3-1 to 3-3 and 4 to 6, user terminal apparatuses 7 and 8, a communication line 11, and access point apparatuses (APs) 12-1 to 12-3.

The image correction apparatus 2 and the server apparatuses 3-1 to 3-3 and 4 to 6 are connected to the communication line 11. The digital camera 1 and the user terminal apparatuses 7 and 8 are wirelessly connected to the access point apparatuses 12-1 to 12-3, respectively, and are connected to the communication line 11 through the access point apparatuses 12-1 to 12-3. The communication line 11 may include a wired communication line, a wireless communication line, or a combination thereof. The communication line 11 includes, for example, the Internet. The access point apparatuses 12-1 to 12-3 may be, for example, wireless LAN access points, or base stations of a cellular telephone network.

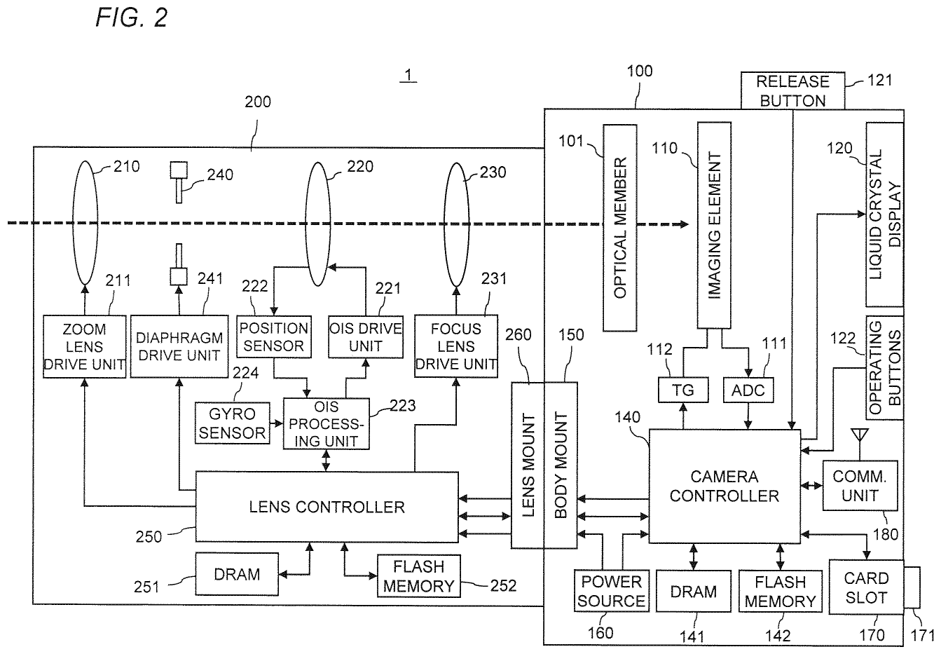

The digital camera 1 transmits a captured digital image (hereinafter, also simply referred to as “image”) to the image correction apparatus 2 through the access point apparatus 12-1 and the communication line 11. The digital camera 1 may transmit the captured image to the server apparatus 5 through the access point apparatus 12-1 and the communication line 11. The digital camera 1 may be provided with a camera body 100, and a lens apparatus 200 detachably connected to the camera body 100, as will be described below with reference to FIG. 2.

The digital camera 1 is an example of an imaging apparatus.

The image correction apparatus 2 corrects the image received from the digital camera 1, using a correction program for correcting images based on individual characteristic information indicating optical characteristics specific to the digital camera 1. The image correction apparatus 2 transmits the corrected image to the digital camera 1 through the communication line 11 and the access point apparatus 12-1, and/or transmits the corrected image to the server apparatus 6 through the communication line 11.

The server apparatus 3-1 stores individual characteristic information indicating optical characteristics specific to the camera body 100. The server apparatus 3-2 stores individual characteristic information indicating optical characteristics specific to a certain lens apparatus 200. The server apparatus 3-3 stores individual characteristic information indicating optical characteristics specific to a further lens apparatus 200. The individual characteristic information stored in the server apparatuses 3-1 to 3-3 may be provided by manufacturers different from each other, respectively. The image correction apparatus 2 receives the individual characteristic information of the camera body 100 and the lens apparatus 200 (that is, individual characteristic information of the digital camera 1) from the server apparatuses 3-1 to 3-3 through the communication line 11.

The server apparatus 4 stores the correction program and its updated versions. The image correction apparatus 2 receives the correction program and its updated versions from the server apparatus 4 through the communication line 11.

The server apparatus 5 receives and stores the captured image (that is, uncorrected image) from the digital camera 1 through the access point apparatus 12-1 and the communication line 11. The server apparatus 5 may receive and store the captured image from the image correction apparatus 2 through the communication line 11. If needed (for example, when the correction program is updated), the user terminal apparatus 7 transmits a control signal to the server apparatus 5 through the access point apparatus 12-2 and the communication line 11, the control signal instructing the image correction apparatus 2 to correct the image stored in the server apparatus 5.

The server apparatus 6 receives and stores the corrected image from the image correction apparatus 2 through the communication line 11. The server apparatus 6 may be configured so that the corrected image stored therein may be accessible to any client apparatuses through the communication line 11. In this case, for example, the user terminal apparatus 8 receives and displays the corrected image from the server apparatus 6 through the access point apparatus 12-3 and the communication line 11.

### [Configuration of Digital Camera]

FIG. 2 is a block diagram showing a configuration of the digital camera 1 of FIG. 1. The digital camera 1 is provided with a camera body 100, and a lens apparatus 200 detachably connected to the camera body 100.

### [Camera Body]

The camera body 100 is provided with an optical member 101, an imaging element 110, an analog/digital converter (ADC) 111, a timing generator (TG) 112, a liquid crystal monitor 120, a release button 121, operating buttons 122, a camera controller 140, a DRAM 141, a flash memory 142, a body mount 150, a power supply 160, a card slot 170, and a communication unit 180.

The body mount 150 is mechanically and electrically connected to a lens mount 260 of the lens apparatus 200, in a detachable manner. The camera body 100 and the lens apparatus 200 communicate with each other through connectors provided on the body mount 150 and the lens mount 260.

Light from a subject is incident on the imaging element 110 through the lens apparatus 200 and the optical member 101. The optical member 101 is a special glass disposed in front of the imaging element 110 with respect to the optical axis of the digital camera 1. The optical member 101 may be, for example, an ND filter of built-in glass type or electronically variable type.

The imaging element 110 receives the light from the subject incident through the lens apparatus 200 and the optical member 101, to generate image data. The image data includes a still image or a moving image. The imaging element 110 operates according to a timing signal generated by the timing generator 112. The image data generated by the imaging element 110 is digitized by the analog/digital converter 111, and the digitized image data is sent to the camera controller 140.

The camera controller 140 performs predetermined image processing on the digitized image data. The image processing may include, for example, at least some of gamma correction, white balance correction, scratch correction, YC conversion, electronic zoom, and JPEG compression. In addition, the camera controller 140 controls operations of the entire digital camera 1, by controlling components, such as the imaging element 110, in accordance with instructions from the release button 121 and the operating buttons 122. The camera controller 140 generates and transmits a vertical synchronization signal to the timing generator 112, and in a parallel manner, generates an exposure synchronization signal. The camera controller 140 periodically transmits the generated exposure synchronization signal to a lens controller 250 of the lens apparatus 200 through the body mount 150 and the lens mount 260. In addition, the camera controller 140 transmits other control signals to the lens controller 250 through the body mount 150 and the lens mount 260. In addition, the camera controller 140 receives identification information and status information (described below) of the lens apparatus 200 from the lens controller 250 through the body mount 150 and the lens mount 260.

The DRAM 141 is used by the camera controller 140 as a work memory for controlling and image processing.

The flash memory 142 stores a firmware program of the camera body 100, identification information of the camera body 100, user settings, and others. The identification information of the camera body 100 includes, for example, a model number and a manufacturing serial number of the camera body 100.

The communication unit 180 is wirelessly connected to the access point apparatus 12-1 of FIG. 1. The communication unit 180 transmits the image captured by the digital camera 1 to the image correction apparatus 2, and receives, from the image correction apparatus 2, an image corrected by the image correction apparatus 2.

The liquid crystal monitor 120 displays the image captured by the digital camera 1, or the image corrected by the image correction apparatus 2. The liquid crystal monitor 120 can selectively display either a still image or a moving image. The moving image includes, for example, a through image that is considered by a user to determine a composition of a still image.

The card slot 170 can receive the memory card 171, and controls the memory card 171 under control of the camera controller 140. The digital camera 1 can store image data in the memory card 171, and read image data from the memory card 171.

The power supply 160 supplies power to components of the digital camera 1. In addition, the power supply 160 also supplies power to the lens apparatus 200 through the body mount 150 and the lens mount 260.

The camera body 100 is an example of the imaging apparatus. The optical member 101 is an example of an optical system of the digital camera 1. In addition, the release button 121 and the operating buttons 122 are an example of an input unit of the digital camera 1. In addition, the communication unit 180 is an example of a communication unit of the digital camera 1, and may be wirelessly or wiredly connected to other apparatuses. In addition, the liquid crystal monitor 120 is an example of a display unit of the digital camera 1.

### [Lens Apparatus]

The lens apparatus 200 is provided with a zoom lens 210, a zoom lens drive unit 211, an optical image stabilizer (OIS) lens 220, an OIS drive unit 221, a position sensor 222, an OIS processing unit 223, a gyro sensor 224, a focus lens 230, a focus lens drive unit 231, a diaphragm device 240, a diaphragm drive unit 241, a lens controller 250, a DRAM 251, a flash memory 252, and a lens mount 260.

The zoom lens 210, the OIS lens 220, the focus lens 230, and the diaphragm device 240 are examples of an optical system of the digital camera 1.

The zoom lens 210 changes the magnification of a subject image formed on the imaging element 110 through the optical system. The zoom lens 210 is constituted of one or more lenses. The zoom lens drive unit 211 moves the zoom lens 210 along the optical axis of the optical system under control of the lens controller 250. The zoom lens drive unit 211 includes, for example, a motor, such as a DC motor, a stepping motor, a servo motor, or an ultrasonic motor.

The diaphragm device 240 adjusts the amount of light incident on the lens apparatus 200 from a subject. The diaphragm device is constituted of a plurality of diaphragm blades. The diaphragm drive unit 241 controls a diaphragm diameter (diaphragm value) of the diaphragm device 240 under control of the lens controller 250. The diaphragm drive unit 241 includes, for example, a motor, such as a DC motor, a stepping motor, a servo motor, or an ultrasonic motor.

The OIS lens 220 reduces the blur of the subject image formed on the imaging element 110 through the optical system, by moving in a direction of at least partially offsetting the shake of the digital camera 1. The OIS lens 220 is constituted of one or more lenses. The position sensor 222 detects the position of the OIS lens 220 in a plane perpendicular to the optical axis of the optical system, and notifies the OIS processing unit 223 of the detected position. The position sensor 222 includes, for example, a magnet and a Hall element. The gyro sensor 224 detects the orientation and the angular velocity of the lens apparatus 200, and notifies the OIS processing unit 223 of the orientation and the angular velocity. The OIS processing unit 223 controls the OIS drive unit 221 based on the position of the OIS lens 220, and the orientation and angular velocity of the lens apparatus 200. The OIS drive unit 221 shifts the OIS lens 220 in the plane perpendicular to the optical axis of the optical system under control of the OIS processing unit 223. The OIS drive unit 221 may include, for example, a magnet and a flat coil, or may include other actuators, such as an ultrasonic motor. By being provided with the OIS drive unit 221, the position sensor 222, the OIS processing unit 223, and the gyro sensor 224, and shifting the OIS lens 220, it is possible to implement the OIS function of correcting the blur of the subject image caused by camera shake due to the user who holds the digital camera 1.

The focus lens 230 changes focusing of a subject image to be formed on the imaging element 110 through the optical system. The focus lens 230 is constituted of one or more lenses. The focus lens drive unit 231 moves the focus lens 230 along the optical axis of the optical system under control of the lens controller 250. The focus lens drive unit 231 includes, for example, a motor, such as a DC motor, a stepping motor, a servo motor, or an ultrasonic motor.

As described above, the lens controller 250 receives the exposure synchronization signal and other control signals from the camera controller 140 through the lens mount 260 and the body mount 150. Under control of the camera controller 140, the lens controller 250 controls operations of the lens apparatus 200, for example, magnification, camera-shake correction status, focus, and diaphragm. In addition, the lens controller 250 transmits identification information and status information of the lens apparatus 200 to the camera controller 140 through the lens mount 260 and the body mount 150. The identification information of the lens apparatus 200 includes, for example, a model number and a manufacturing serial number of the lens apparatus 200. The status information of the lens apparatus 200 includes, for example, a magnification (position of the zoom lens 210), a camera-shake correction status (position of the OIS lens 220), a focus (position of the focus lens 230), and a diaphragm (diaphragm value), when the digital camera 1 captures an image.

The DRAM 251 is used by the lens controller 250 as a working memory for controlling.

The flash memory 252 stores a firmware program of the lens apparatus 200, the identification information of the lens apparatus 200, user settings, and others.

### [Configuration of Image Correction Apparatus]

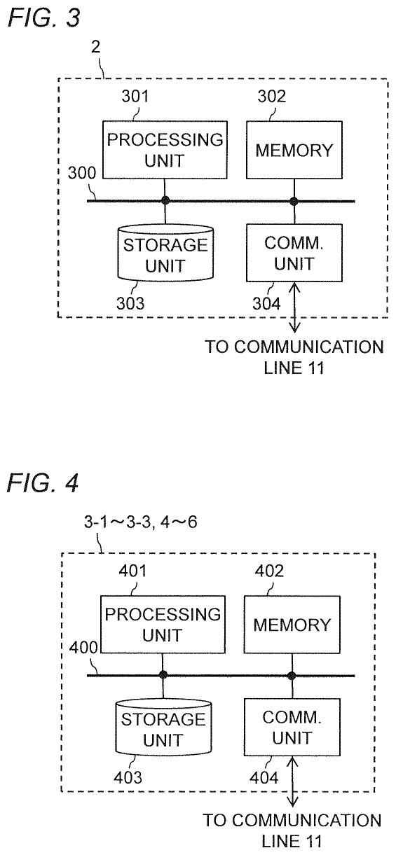

FIG. 3 is a block diagram showing a configuration of the image correction apparatus 2 of FIG. 1. The image correction apparatus 2 is provided with a bus 300, a processing unit 301, a memory 302, a storage unit 303, and a communication unit 304. The processing unit 301 controls operations of the entire image correction apparatus 2. The memory 302 temporarily stores programs and data necessary for the operations of the image correction apparatus 2. The storage unit 303 is a non-volatile storage medium that stores programs necessary for the operations of the image correction apparatus 2, including a correction program for correcting images. The communication unit 304 is communicably connected to the digital camera 1 and the server apparatuses 3-1 to 3-3 and 4 to 6 through the communication line 11, The communication unit 304 receives, for example, the image captured by the digital camera 1 and the identification information of the digital camera 1, from the digital camera 1. The processing unit 301 obtains individual characteristic information indicating optical characteristics specific to the digital camera 1, based on the identification information, and performs predetermined digital image processing using the correction program based on the individual characteristic information, thus correcting the image. The processing unit 301, the memory 302, the storage unit 303, and the communication unit 304 are connected to each other through the bus 300.

### [Configuration of Server Apparatuses]

FIG. 4 is a block diagram showing a configuration of the server apparatuses 3-1 to 3-3 and 4 to 6 of FIG. 1. Each of the server apparatuses 3-1 to 3-3 and 4 to 6 is provided with a bus 400, a processing unit 401, a memory 402, a storage unit 403, and a communication unit 404. The processing unit 401 controls operations of the entire server apparatus 3-1, 3-2, 3-3, 4, 5 or 6. The memory 402 temporarily stores programs and data necessary for the operations of the server apparatus 3-1, 3-2, 3-3, 4, 5 or 6. The storage unit 403 is a non-volatile storage medium that stores programs necessary for the operations of the server apparatus 3-1, 3-2, 3-3, 4, 5 or 6. In addition, the storage unit 403 of the server apparatuses 3-1 to 3-3 stores the individual characteristic information of the camera body 100 and the lens apparatus 200. In addition, the storage unit 403 of the server apparatus 4 stores the correction program and its updated versions. In addition, the storage unit 403 of the server apparatus 5 stores the captured image (that is, uncorrected image). In addition, the storage unit 403 of the server apparatus 6 stores the corrected image. The communication unit 404 is communicably connected to the image correction apparatus 2 through the communication line 11. The processing unit 401, the memory 402, the storage unit 403, and the communication unit 404 are connected to each other through the bus 400.

### [Configuration of User Terminal Apparatuses]

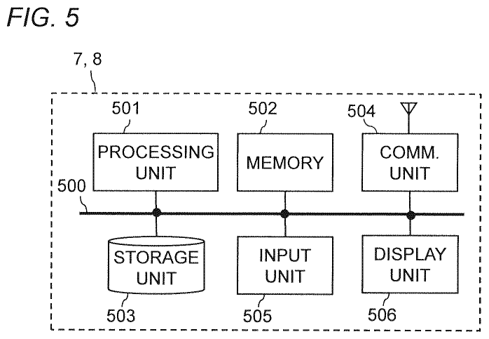

FIG. 5 is a block diagram showing a configuration of the user terminal apparatuses 7 and 8 of FIG. 1. Each of the user terminal apparatuses 7 and 8 is provided with a bus 500, a processing unit 501, a memory 502, a storage unit 503, a communication unit 504, an input unit 505, and a display unit 506. The processing unit 501 controls operations of the entire user terminal apparatus 7 or 8. The memory 502 temporarily stores programs and data necessary for the operations of the user terminal apparatus 7 or 8. The storage unit 503 is a non-volatile storage medium that stores programs necessary for the operations of the user terminal apparatus 7 or 8. The communication unit 504 of the user terminal apparatus 7 is communicably connected to the image correction apparatus 2 and the server apparatus 5 through the communication line 11. The communication unit 504 of the user terminal apparatus 8 is communicably connected to the server apparatus 6 through the communication line 11. The display unit 506 displays information related to the status of the user terminal apparatus 7 or 8. The input unit 505 receives user inputs for controlling the operations of the user terminal apparatus 7 or 8. The input unit 505 includes, for example, a touch panel, a keyboard, and/or a pointing device. The processing unit 501, the memory 502, the storage unit 503, the communication unit 504, the input unit 505, and the display unit 506 are connected to each other through the bus 500.

The user terminal apparatuses 7 and 8 may be, for example, smartphones, tablet terminal apparatuses, or other personal computers.

### [Obtaining Individual Characteristic Information]

As described above, the digital camera 1 may produce undesirable distortion and unevenness in a captured image, due to design or manufacturing variations. Therefore, the optical characteristics of the digital camera 1 are obtained during or after manufacturing, and individual characteristic information indicating the optical characteristics specific to the digital camera 1 is generated in advance. The individual characteristic information of the digital camera 1 includes at least one of the design information of the digital camera 1, and a measurement result of an optical characteristic of the digital camera 1. The image correction apparatus 2 corrects the image using the correction program based on the individual characteristic information.

The individual characteristic information of the digital camera 1 includes, for example, sensor luminance unevenness, sensor color unevenness, decrease in peripheral illumination, decrease in resolution, optical chromatic aberration, and optical distortion.

The sensor luminance unevenness and the sensor color unevenness are individual characteristic information indicating optical characteristics specific to the camera body 100. The sensor luminance unevenness and the sensor color unevenness indicate unevenness in luminance and color of the captured image caused by design or manufacturing variations of pixels of the imaging element 110, respectively. In addition, luminance and color of a captured image may have distributions (unevenness) known from the design information of the camera body 100. In this case, the sensor luminance unevenness and the sensor color unevenness may include changes from the known distributions of luminance and color of the captured image, respectively, caused by the eccentricity of the optical member 101 or the imaging element 110.

The decrease in peripheral illumination, the decrease in resolution, the optical chromatic aberration, and the optical distortion are individual characteristic information indicating optical characteristics specific to the lens apparatus 200. The decrease in peripheral illumination indicates a decrease in illumination of the periphery remote from the center of the captured image, caused by the design of the lens apparatus 200. The decrease in resolution indicates a decrease in resolution of a certain region of the captured image, caused by the design of the lens apparatus 200. The illumination and resolution of the captured image have distributions known from the design information of the lens apparatus 200. The decrease in peripheral illumination and the decrease in resolution may include changes from the known distributions of illumination and resolution of the captured image, respectively, caused by the eccentricity of lenses of the lens apparatus 200. The optical chromatic aberration and the optical distortion indicate chromatic aberration and distortion of the captured image, respectively, caused by design or manufacturing variations of the lens apparatus 200.

In a case where the digital camera 1 is provided with the camera body 100 and the lens apparatus 200, the individual characteristic information of the digital camera 1 includes the individual characteristic information of the camera body 100, and the individual characteristic information of the lens apparatus 200.

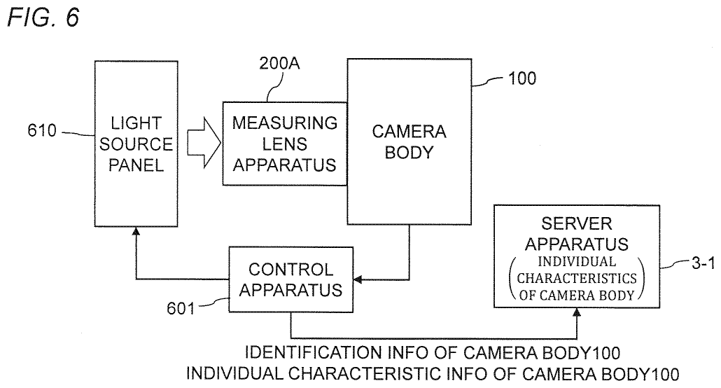

FIG. 6 is a block diagram showing an arrangement for obtaining individual characteristic information of the camera body 100 of FIG. 2 through measurement, and providing the individual characteristic information to the server apparatus 3-1 of FIG. 1. The measuring lens apparatus 200A has known optical characteristics, and is mounted on the camera body 100 to be measured. The measuring lens apparatus 200A has a similar configuration to that of the lens apparatus 200 of FIG. 2. The light source panel 610 is configured so that test light with uniform intensity and the same color is incident on the entire surface of the imaging element 110 of the camera body 100. The control apparatus 601 controls the light source panel 610 so that the test light is incident on the camera body 100 through the measuring lens apparatus 200A. The control apparatus 601 obtains an image generated by the imaging element 110 from the camera body 100 via wireless connection (the communication unit 180 of FIG. 2) or a further interface (for example, USB or the like). The control apparatus 601 measures the sensor luminance unevenness and the sensor color unevenness of the camera body 100 based on the luminance and color of the respective pixels of the image generated by the imaging element 110. In order to measure the sensor luminance unevenness caused by the optical member 101, the control apparatus 601 may perform gain enhancement on the image generated by the imaging element 110. The control apparatus 601 transmits the individual characteristic information including the sensor luminance unevenness and the sensor color unevenness of the camera body 100, together with the identification information of the camera body 100, to the server apparatus 3-1.

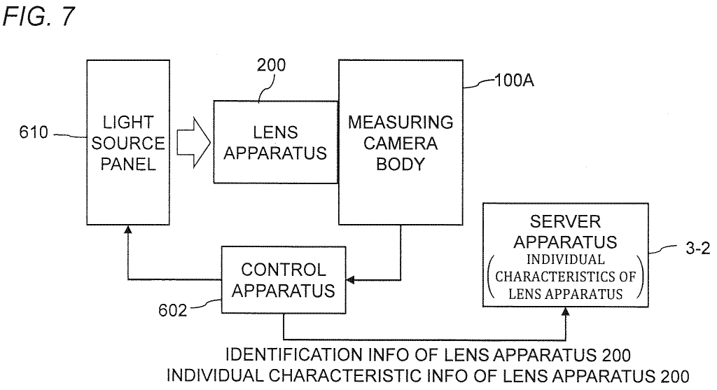

FIG. 7 is a block diagram showing an arrangement for obtaining individual characteristic information of the lens apparatus 200 of FIG. 2 through measurement, and providing the individual characteristic information to the server apparatus 3-2 of FIG. 1. The measuring camera body 100A has known optical characteristics, and the lens apparatus 200 to be measured is mounted on the measuring camera body 100A. The measuring camera body 100A has a similar configuration to that of the camera body 100 of FIG. 2. The control apparatus 602 controls the light source panel 610 so that the test light is incident on the measuring camera body 100A through the lens apparatus 200. The control apparatus 602 obtains an image generated by the imaging element 110 from the measuring camera body 100A via wireless connection or a further interface. The control apparatus 602 measures a decrease in peripheral illumination of the lens apparatus 200 based on the luminance of the respective pixels of the image generated by the imaging element 110. The control apparatus 602 transmits the individual characteristic information including the decrease in peripheral illumination of the lens apparatus 200, together with the identification information of the lens apparatus 200, to the server apparatus 3-2.

A decrease in resolution, optical chromatic aberration, and optical distortion of the lens apparatus 200 may be measured using the arrangement of FIG. 7. In this case, the light source panel 610 is configured so that test patterns having predetermined shapes are incident on the imaging element 110 of the camera body 100. The control apparatus 602 measures a decrease in resolution, optical chromatic aberration, and optical distortion of the lens apparatus 200 based on the luminance and color of the respective pixels of the image generated by the imaging element 110. The control apparatus 602 transmits individual characteristic information including the decrease in resolution, the optical chromatic aberration, and the optical distortion of the lens apparatus 200, together with the identification information of the lens apparatus 200, to the server apparatus 3-2.

The lens apparatus 200 of FIG. 2 has a variable magnification, a variable diaphragm, a variable camera-shake correction status, and a variable focus, and its optical characteristics may vary according to changes in the magnification, the diaphragm, the camera-shake correction status, and the focus. Therefore, the control apparatus 602 of FIG. 7 may change the magnification, the diaphragm, the camera-shake correction status, and the focus of the lens apparatus 200, and measure individual characteristic information of the lens apparatus 200 for a plurality of magnifications, a plurality of diaphragms, a plurality of camera-shake correction statuses, and a plurality of foci.

The individual characteristic information known from the design information of the camera body 100 and the lens apparatus 200 may be stored in advance in the server apparatuses 3-1 to 3-3 together with the identification information thereof. In addition, for optical characteristics supposed to yield little manufacturing variations (for example, optical chromatic aberration and optical distortion), the server apparatuses 3-1 to 3-3 may store only the individual characteristic information based on the design information, without measurement the optical characteristics. The individual characteristic information based on the design information is applied to all the camera bodies 100 or the lens apparatuses 200 having the same model number.

The server apparatus 3-1 stores individual characteristic information of the camera body 100, for example, as shown in the following table.

| MODEL | MANUFACTURING | INDIVIDUAL CHARACTERISTIC |
|---|---|---|
| NUMBER | SERIAL NUMBER | INFORMATION |
| A | 01 | C-A-01 |
| A | 02 | C-A-02 |
| B | 01 | C-B-01 |
| . . . | | |

The model numbers “A” and “B” indicate camera bodies 100 of models different from each other. The first and second rows of the table show different individuals of the same model. The individual camera body 100 is represented by a combination of a model number and a manufacturing serial number. The server apparatus 3-1 stores, per each camera body 100, individual characteristic information C-A-01, C-A-02, C-B-01, or the like thereof.

The server apparatus 3-2 stores individual characteristic information of the lens apparatus 200, for example, as shown in the following table.

| MODEL | MANUFACTURING | INDIVIDUAL CHARACTERISTIC |
|---|---|---|
| NUMBER | SERIAL NUMBER | INFORMATION |
| X | 01 | C-X-01 |
| X | 02 | C-X-02 |
| Y | 01 | C-Y-01 |
| . . . | | |

The model numbers “X” and “Y” indicate lens apparatuses 200 of models different from each other. The first and second rows of the table show different individuals of the same model. The individual lens apparatus 200 is represented by a combination of a model number and a manufacturing serial number. The server apparatus 3-2 stores, per each lens apparatus 200, individual characteristic information C-X-01, C-X-02, C-Y-01, or the like thereof.

The model number and the manufacturing serial number are not limited to only numerals, and may be a combination of numerals, alphabets, and other symbols.

As described above, the individual characteristic information stored in the server apparatuses 3-1 to 3-3 may be provided by manufacturers different from each other, respectively. In general, since the camera body 100 and the lens apparatus 200 are provided by manufacturers different from each other, the individual characteristic information of the camera body 100 stored in the server apparatus 3-1, and the individual characteristic information of the lens apparatus 200 stored in the server apparatuses 3-2 to 3-3 may be provided by manufacturers different from each other. In addition, since a plurality of types of lens apparatuses 200 can be mounted on the camera body 100, the individual characteristic information of the lens apparatus 200 stored in the server apparatuses 3-2 to 3-3 may be provided by manufacturers different from each other, respectively.

The correction program corrects the captured image to reduce undesirable distortion, unevenness, and others in the captured image based on the individual characteristic information of the camera body 100 and the lens apparatus 200. In addition, the correction program may correct the captured image based on the status information of the lens apparatus 200 (magnification, diaphragm, camera-shake correction status, and focus). The correction program may be a function including parameters, such as the optical characteristics of the camera body 100 and the lens apparatus 200, and the magnification, the diaphragm, the camera-shake correction status, and the focus of the lens apparatus. In addition, the correction program may be a combination of a plurality of tables selected based on the optical characteristics of the camera body 100 and the lens apparatus 200, and the magnification, the diaphragm, the camera-shake correction status, and the focus of the lens apparatus. The correction program may be provided by, for example, a manufacturer of the camera body 100.

The server apparatus 4 stores a correction program, for example, as shown in the following table.

| MODEL NUMBER | CORRECTION PROGRAM |
|---|---|
| A | P-A ver. 1.0 |
| A | P-A ver. 1.1 |
| B | P-B ver. 1.0 |
| . . . | |

In this example, multiple versions of correction programs are stored for a camera body 100 having a model number “A”.

### [Operation of Digital Camera]

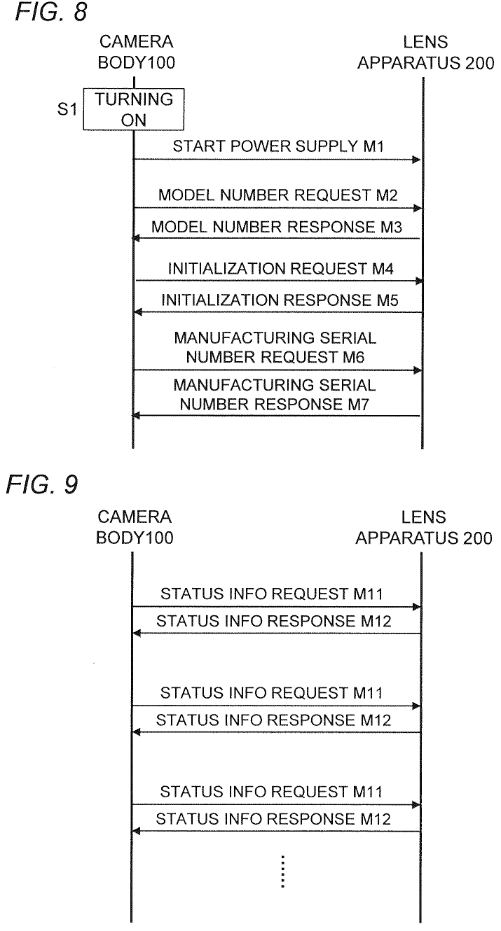

FIG. 8 is a sequence diagram showing initial communication between the camera body 100 and the lens apparatus 200, immediately after the digital camera 1 of FIG. 2 is powered on. In step S1, the camera body 100 is powered on, and starts power supply M1 from the camera body 100 to the lens apparatus 200. After starting the power supply M1, the camera body 100 transmits a model number request signal M2 to the lens apparatus 200. In response to the model number request signal M2, the lens apparatus 200 transmits a model number response signal M3 including the model number of the lens apparatus 200, to the camera body 100. Upon receiving the model number of the lens apparatus 200, the camera body 100 authenticates the lens apparatus 200. Next, the camera body 100 transmits an initialization request signal M4 to the lens apparatus 200. Upon receiving the initialization request signal M4, the lens apparatus 200 initializes the lens apparatus 200 by moving the zoom lens 210, the OIS lens 220, the focus lens 230, and the diaphragm device 240 to predetermined initial positions, or to last positions when the camera body 100 is powered off most recently, and then, transmits an initialization response signal M5 to the camera body 100. Next, the camera body 100 transmits a manufacturing serial number request signal M6 to the lens apparatus 200. In response to the manufacturing serial number request signal M6, the lens apparatus 200 transmits a manufacturing serial number response signal M7 including the manufacturing serial number of the lens apparatus 200, to the camera body 100. When the camera body 100 has obtained the model number and the manufacturing serial number of the lens apparatus 200 (that is, the identification information of the lens apparatus 200), the initial communication between the camera body 100 and the lens apparatus 200 is completed.

FIG. 9 is a sequence diagram showing normal communication between the camera body 100 and the lens apparatus 200, when the digital camera 1 of FIG. 2 captures an image. The camera body 100 periodically transmits a status information request signal M11 to the lens apparatus 200. In response to the status information request signal M11, the lens apparatus 200 transmits a status information response signal M12 including current status information of the lens apparatus 200 (that is, current magnification, diaphragm, camera-shake correction status, and focus of the lens apparatus 200) to the camera body 100.

In a case where a camera body corrects an image as in the prior art, it is necessary to store, in advance, individual characteristic information of a lens apparatus in a non-volatile storage apparatus within the lens apparatus, and transmit the individual characteristic information of the lens apparatus from the lens apparatus to the camera body. On the other hand, according to the image correction system 20 of the embodiment, the individual characteristic information of the lens apparatus 200 is stored in the server apparatus 3-2 or 3-3, and transmitted from the server apparatus 3-2 or 3-3 to the image correction apparatus 2. Therefore, according to the image correction system 20 of the embodiment, it is not necessary to provide the lens apparatus 200 with a mass and nonvolatile storage device, and therefore, it is possible to reduce the circuit size and cost of the lens apparatus 200 as compared with the prior art. Furthermore, according to the image correction system 20 of the embodiment, it is possible to reduce the amount of communication between the camera body 100 and the lens apparatus 200.

### [Correction Process of Captured Image]

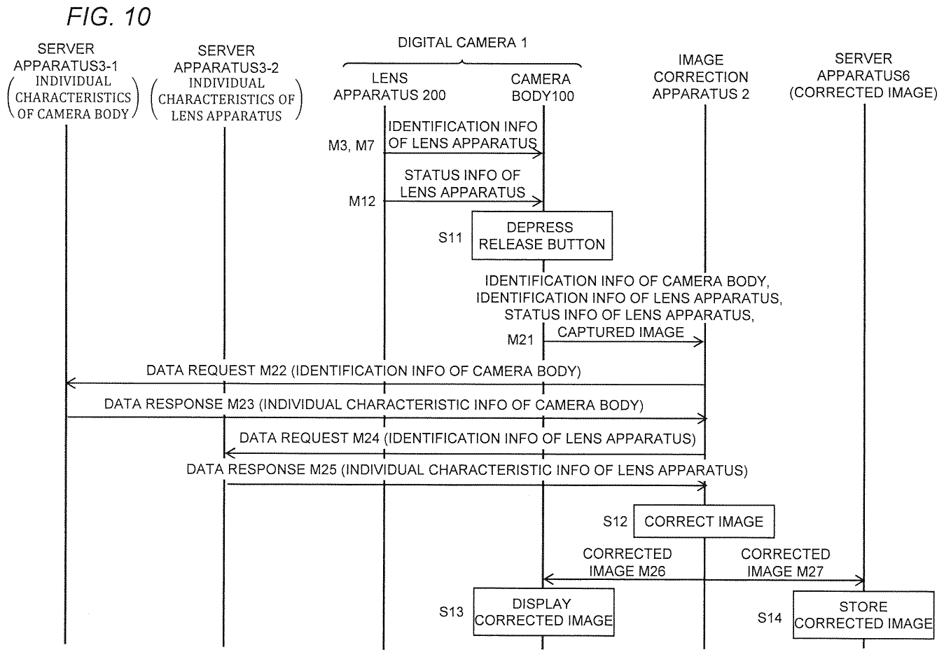

FIG. 10 is a sequence diagram for the image correction system 20 of FIG. 1, showing a correction process in which the image correction apparatus 2 corrects an image captured by the digital camera 1.

At first, in the digital camera 1, as described with reference to FIGS. 8 and 9, the signals M3 and M7 including the identification information of the lens apparatus 200 are transmitted from the lens apparatus 200 to the camera body 100 as the initial communication, and the signal M12 including the status information of the lens apparatus 200 is transmitted from the lens apparatus 200 to the camera body 100 as the normal communication. Next, in step S11, by the user depressing the release button 121, the digital camera 1 captures an image. When the digital camera 1 has captured an image, the communication unit 180 of the digital camera 1 transmits one or more signals M21 to the image correction apparatus 2, the signal M21 including the identification information of the camera body 100, the identification information of the lens apparatus 200, the status information of the lens apparatus 200, and the captured image.

The identification information of the camera body 100, the identification information of the lens apparatus 200, the status information of the lens apparatus 200, and the captured image may be transmitted from the digital camera 1 to the image correction apparatus 2, for example, as a file having the following format.

### <Header>

image size (number of horizontal pixels and number of vertical pixels)
still image file format
data length
identification information of lens apparatus 200 (model number and manufacturing serial number)
identification information of camera body 100 (model number and manufacturing serial number)
status information of lens apparatus 200 (magnification, diaphragm, camera-shake correction status, and focus)

### <Data Body>

captured image

The identification information of the camera body 100 and the lens apparatus 200 may be transmitted separately from the captured image, instead of being embedded in the header. In this case, the header of the file including the captured image includes a unique identifier associated with the captured image, instead of the identification information of the camera body 100 and the lens apparatus 200. Together with the same identifier, the identification information of the camera body 100 and the lens apparatus 200 is transmitted from the digital camera 1 to the image correction apparatus 2.

The communication unit 180 of the digital camera 1 may transmit, to the server apparatus 5, the identification information of the camera body 100, the identification information of the lens apparatus 200, the status information of the lens apparatus 200, and the captured image. In this case, the communication unit 404 of the server apparatus 5 receives the identification information of the camera body 100, the identification information of the lens apparatus 200, the status information of the lens apparatus 200, and the captured image. The storage unit 403 of the server apparatus 5 stores the identification information of the camera body 100, the identification information of the lens apparatus 200, the status information of the lens apparatus 200, and the captured image.

The communication unit 304 of the image correction apparatus 2 receives the one or more signals M21 from the digital camera 1, the signal M21 including the identification information of the camera body 100, the identification information of the lens apparatus 200, the status information of the lens apparatus 200, and the captured image.

The communication unit 304 of the image correction apparatus 2 transmits a data request signal M22 including the identification information of the camera body 100, to the server apparatus 3-1. In response to the data request signal M22, the communication unit 404 of the server apparatus 3-1 transmits a data response signal M23 to the image correction apparatus 2, the signal M23 including the individual characteristic information of the camera body 100 identified by the identification information.

The communication unit 304 of the image correction apparatus 2 transmits a data request signal M24 including the identification information of the lens apparatus 200, to the server apparatus 3-2. In response to the data request signal M24, the communication unit 404 of the server apparatus 3-2 transmits a data response signal M25 to the image correction apparatus 2, the signal M25 including the individual characteristic information of the lens apparatus 200 identified by the identification information.

The communication unit 304 of the image correction apparatus 2 receives the signals M23 and M25 including the individual characteristic information of the camera body 100 and the lens apparatus 200, from the server apparatuses 3-1 and 3-2, respectively. In step S12, the processing unit 301 of the image correction apparatus 2 corrects the image received from the digital camera 1 using the correction program based on the individual characteristic information of the camera body 100 and the lens apparatus 200. In addition, the processing unit 301 of the image correction apparatus 2 may correct the image received from the digital camera 1 using the correction program, based on the individual characteristic information of the camera body 100 and the lens apparatus 200, and the status information of the lens apparatus 200. Thereafter, the communication unit 304 of the image correction apparatus 2 transmits signals M26 and M27 including the corrected image to the digital camera 1 and the server apparatus 6, respectively.

The communication unit 180 of the digital camera 1 receives the signal M26 including the corrected image. In step S13, the liquid crystal monitor 120 of the digital camera 1 displays the corrected image.

In addition, the communication unit 404 of the server apparatus 6 receives the signal M27 including the corrected image. In step S14, the storage unit 403 of the server apparatus 6 stores the corrected image. For example, the image stored in the server apparatus 6 may be read by the user terminal apparatus 8, and displayed on the display unit 506 of the user terminal apparatus 8.

According to the first embodiment, the digital camera 1 does not need to be provided with a correction circuit or a correction program, and therefore, it is possible to reduce the circuit size and cost of the digital camera 1 as compared with the prior art. In addition, according to the first embodiment, the digital camera 1 does not need power for operating a correction circuit nor power for executing a correction program, and therefore, it is possible to reduce power consumption of the digital camera 1 as compared with the prior art.

In addition, according to the first embodiment, the individual characteristic information of the digital camera 1 is stored in the server apparatuses 3-1 to 3-3, instead of within the digital camera 1, and therefore, it is not necessary to provide the digital camera 1 with a mass and nonvolatile storage device, and it is possible to reduce the circuit size and cost of the digital camera as compared with the prior art.

As described above, according to the first embodiment, it is possible to correct undesirable distortion, unevenness, and others in a captured image, while reducing the circuit size, cost, and/or power consumption of the digital camera 1 as compared with the prior art.

In addition, conventionally, once a digital camera is manufactured and shipped, its correction circuit cannot be replaced with a higher-performance circuit. In addition, even in a case where the digital camera is provided with a correction program, it has been difficult to install and execute an updated correction program having any size or any processing load, in the digital camera, due to hardware limitations of the digital camera. On the other hand, according to the first embodiment, since the image correction apparatus 2 executes the correction program, it is possible to execute an updated correction program having any size or any processing load, without being subject to hardware limitations of the digital camera 1. According to the first embodiment, it is possible to easily use the latest correction program to correct undesirable distortion, unevenness, and others in a captured image, while reducing the circuit size, cost, and/or power consumption of the digital camera 1 as compared with the prior art.

According to the first embodiment, it is possible to correct the image captured by the digital camera 1, and improve the quality of the image.

### [Correction Process of Preview Image]

The image correction process described above can also be applied to the case of correcting each frame of the digital moving image (hereinafter, also simply referred to as a “moving image”). Therefore, for example, as a preview image displayed on the liquid crystal monitor 120 of the digital camera 1, the image correction system 20 may display the image corrected by the image correction apparatus 2, instead of the captured image (that is, uncorrected image).

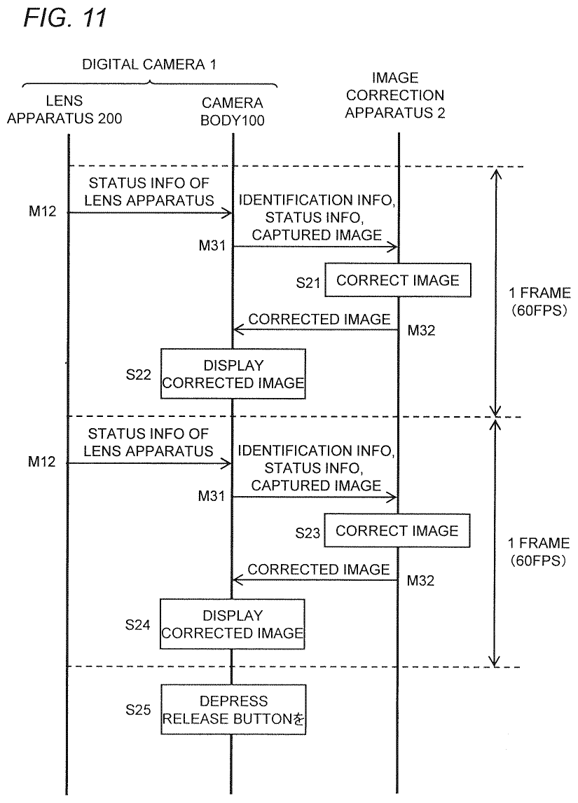

FIG. 11 is a sequence diagram for the image correction system 20 of FIG. 1, showing a correction process in which the image correction apparatus 2 corrects a preview image to be displayed on the digital camera 1.

The process of FIG. 11 is executed after the image correction apparatus 2 obtains the identification information of the camera body 100 and the lens apparatus 200 from the digital camera 1, and obtains the individual characteristic information of the camera body 100 and the lens apparatus 200 from the server apparatuses 3-1 and 3-2 based on the identification information of the camera body 100 and the lens apparatus 200, in a manner similar to that of the process of FIG. 10. The process of FIG. 11 is executed, for example, per each frame of a moving image of 60 frames per second.

The camera body 100 receives the signal M12 including the status information of the lens apparatus 200, from the lens apparatus 200. The imaging element 110 of the digital camera 1 receives light incident through the optical system to generate a moving image (that is, a series of frames). The communication unit 180 of the digital camera 1 transmits a signal M31 to the image correction apparatus 2, the signal M31 including an image currently generated by the imaging element 110 (that is, one frame of the moving image), together with the identification information of the camera body 100, the identification information of the lens apparatus 200, and the status information of the lens apparatus 200.

The identification information of the camera body 100, the identification information of the lens apparatus 200, the status information of the lens apparatus 200, and the captured image may be transmitted from the digital camera 1 to the image correction apparatus 2, for example, as a file having the following format.

```
  <header>
  - image size (number of horizontal pixels and number of vertical pixels)
  - moving image file format
  - frame rate
  - identification information of lens apparatus 200 (model number and
manufacturing serial number)
  - identification information of camera body 100 (model number and
manufacturing serial number)
<first frame data>
  - data length
  - status information of lens apparatus 200 (magnification, diaphragm,
camera-shake correction status, and focus)
  - captured image
<second frame data>
  (Omitted)
  ...
<N-th frame data>
  - data length
  - status information of lens apparatus 200 (magnification, diaphragm,
camera-shake correction status, and focus)
  - captured image
```

The identification information of the camera body 100 and the lens apparatus 200 may be transmitted separately from the captured image, instead of being embedded in the header. In this case, the header of the file including the captured image includes a unique identifier associated with the captured image, instead of the identification information of the camera body 100 and the lens apparatus 200. Together with the same identifier, the identification information of the camera body 100 and the lens apparatus 200 is transmitted from the digital camera 1 to the image correction apparatus 2.

As described above, in a case of correcting one still image, the status information of the lens apparatus 200 may be embedded in the header of the file including the image. On the other hand, in a case of correcting frames of the moving image, the status information of the lens apparatus 200 is embedded per each frame. In a case where the magnification, the diaphragm, the camera-shake correction status, or the focus of the lens apparatus 200 changes during capturing of the moving image, status information including the changed value is embedded in the current frame.

The communication unit 304 of the image correction apparatus 2 receives a signal M31 from the digital camera 1, the signal M31 including the identification information of the camera body 100, the identification information of the lens apparatus 200, the status information of the lens apparatus 200, and the captured image. In step S21, the processing unit 301 of the image correction apparatus 2 corrects the image of the current frame using the correction program based on the individual characteristic information of the camera body 100 and the lens apparatus 200. In addition, the processing unit 301 of the image correction apparatus 2 may correct the image of the current frame using the correction program, based on the individual characteristic information of the camera body 100 and the lens apparatus 200, and the status information of the lens apparatus 200. The processing unit 301 of the image correction apparatus 2 can correct the moving image by correcting the series of frames using the correction program. Thereafter, the communication unit 304 of the image correction apparatus 2 transmits a signal M32 including the corrected image to the digital camera 1.

The communication unit 180 of the digital camera 1 receives the signal M32 including the corrected image from the image correction apparatus 2. In step S22, the liquid crystal monitor 120 of the digital camera 1 displays the corrected image. In addition, the camera controller 140 may output the corrected image from the communication unit 180 to an external display monitor via a wireless connection or a wired connection.

Thereafter, the image correction system 20 repeats the above-described process per each frame. The user depresses the release button 121 to obtain a desired image.

According to the process of FIG. 11, it is possible to correct undesirable distortion, unevenness, and others in the captured moving image, while reducing the circuit size, cost, and/or power consumption of the digital camera 1 as compared with the prior art, in a manner similar to the case of the still image.

According to the process of FIG. 11, it is possible to correct and display the captured image in real time to present the corrected preview image in real time.

### [Correction Process of Stored Image]

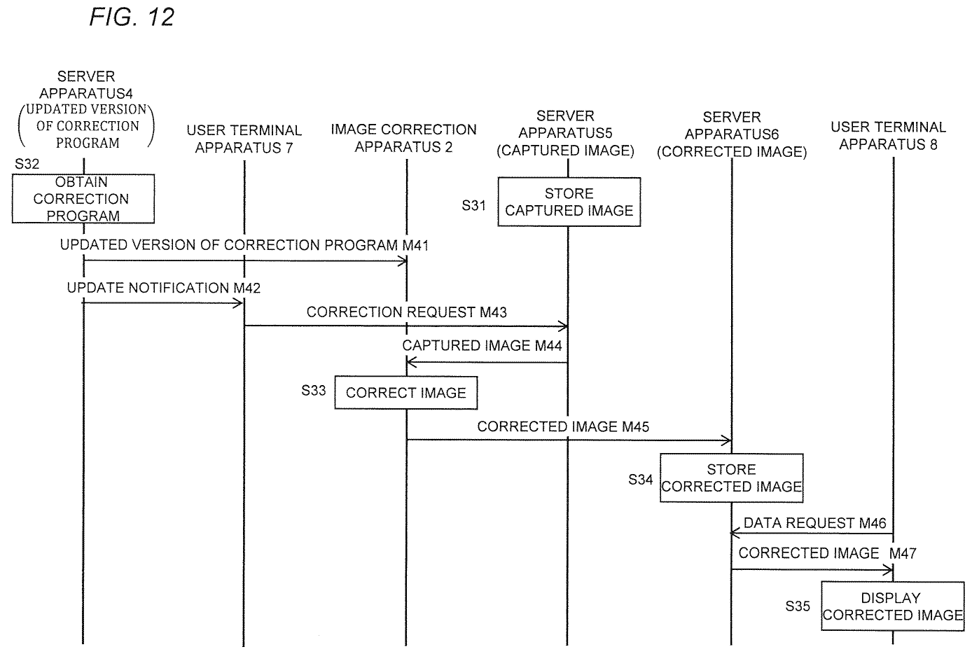

FIG. 12 is a sequence diagram for the image correction system 20 of FIG. 1, showing a correction process to be performed, when a correction program is updated, on an image having been temporarily stored in the server apparatus 5.

In step S31, as described above, the server apparatus 5 stores, in the storage unit 403, the image captured by the digital camera 1 (that is, uncorrected image), together with the identification information of the camera body 100, the identification information of the lens apparatus 200, and the status information of the lens apparatus 200.

In step S32, the server apparatus 4 obtains an updated version of a correction program for a certain digital camera 1, and stores the updated version in the storage unit 403. When the updated version of correction program is obtained, the communication unit 404 of the server apparatus 4 transmits a signal M41 including the updated version of correction program, to the image correction apparatus 2. In addition, in a case where the user of the digital camera 1 has registered, with the server apparatus 4, the user terminal apparatus 7 (alternatively, an Email address or the like available to the user terminal apparatus 7) as the contact information of the user, the communication unit 404 of the server apparatus 4 transmits an update notification signal M42 to the user terminal apparatus 7, the signal M42 indicating that the updated version of correction program has been obtained.

The communication unit 304 of the image correction apparatus 2 receives the signal M41 including the updated version of correction program, from the server apparatus 4. The storage unit 303 of the image correction apparatus 2 stores the updated version of correction program.

The communication unit 504 of the user terminal apparatus 7 receives the update notification signal M42. Upon receiving the update notification signal M42, the user of the user terminal apparatus 7 determines whether or not to cause the image correction apparatus 2 to correct an image stored in the server apparatus 5. In response to the determination by the user, the communication unit 504 of the user terminal apparatus 7 transmits a correction request signal M43 to the server apparatus 5, the signal M43 instructing the image correction apparatus 2 to correct the image stored in the server apparatus 5.

Upon receiving the correction request signal M43, the communication unit 404 of the server apparatus 5 transmits a signal M44 to the image correction apparatus 2, the signal M44 including the captured image stored in the storage unit 403, together with the identification information of the camera body 100, the identification information of the lens apparatus 200, and the status information of the lens apparatus 200.

The communication unit 304 of the image correction apparatus 2 receives the signal M41 including the updated version of correction program, from the server apparatus 4, and thereafter, receives the signal M44 from the server apparatus 5, the signal M44 including the identification information of the camera body 100, the identification information of the lens apparatus 200, the status information of the lens apparatus 200, and the captured image. The communication unit 304 of the image correction apparatus 2 obtains the individual characteristic information of the camera body 100 and the lens apparatus 200 from the server apparatuses 3-1 and 3-2 based on the identification information of the camera body 100 and the lens apparatus 200, respectively. In step S33, the processing unit 301 of the image correction apparatus 2 corrects the image received from the server apparatus 5 using the correction program based on the individual characteristic information of the camera body 100 and the lens apparatus 200. In addition, the processing unit 301 of the image correction apparatus 2 may correct the image received from the server apparatus 5 using the correction program, based on the individual characteristic information of the camera body 100 and the lens apparatus 200, and the status information of the lens apparatus 200. Thereafter, the communication unit 304 of the image correction apparatus 2 transmits a signal M45 including the corrected image, to the server apparatus 6.

The communication unit 404 of the server apparatus 6 receives the signal M45 including the corrected image. In step S34, the storage unit 403 of the server apparatus 6 stores the corrected image.

As described above, the server apparatus 6 may be configured so that the corrected image stored therein may be accessible to any client apparatuses through the communication line 11. In this case, the communication unit 504 of the user terminal apparatus 8 transmits a data request signal M46 to the server apparatus 6. In response to the data request signal M46, the communication unit 404 of the server apparatus 6 transmits a signal M47 including the corrected image stored therein, to the user terminal apparatus 8. The communication unit 504 of the user terminal apparatus 8 receives the signal M47 including the corrected image. In step S35, the display unit 506 of the user terminal apparatus 8 displays the corrected image.

In the example of FIG. 12, the case has been described where upon obtaining an updated version of correction program, the server apparatus 4 transmits the updated version of correction program to the image correction apparatus 2. Alternatively, the image correction apparatus 2 may periodically inquire of the server apparatus 4 about the presence or absence of an updated version of correction program.

According to the process of FIG. 12, for example, in a case where the user terminal apparatus 7 is used by an online streamer, and the user terminal apparatus 8 is used by a viewer, it is possible to promptly provide the viewer with a corrected moving image having improved quality when the updated version of correction program is provided.

### [Selecting Version of Correction Program]

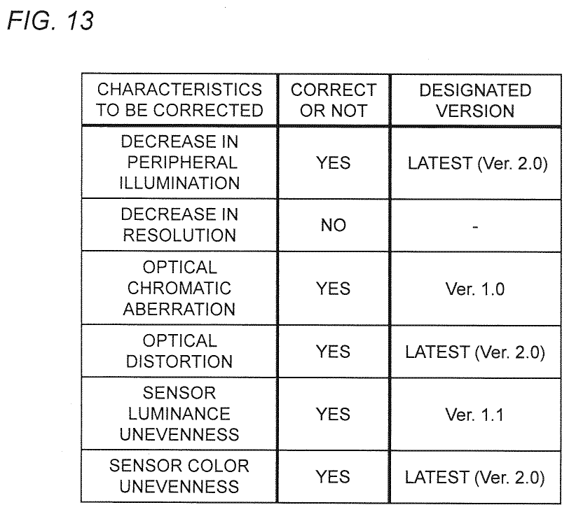

FIG. 13 is a diagram showing a table displayed on the display unit of the digital camera 1 or the user terminal apparatus 7, in a case where the image correction apparatus 2 of FIG. 1 stores multiple versions of correction program.

The example of FIG. 13 shows a case of using distinct correction programs each having multiple versions, in order to correct various optical characteristics of the digital camera 1, that is, the sensor luminance unevenness, the sensor color unevenness, the decrease in peripheral illumination, the decrease in resolution, the optical chromatic aberration, and the optical distortion. It is possible to individually set whether or not to correct each of the optical characteristics (that is, whether or not to be applied to an image).

The storage unit 303 of the image correction apparatus 2 stores multiple versions of correction program for each of one or more optical characteristics. The communication unit 304 of the image correction apparatus 2 transmits, to the digital camera 1, a list of multiple versions of correction program available to the image correction apparatus 2.

The communication unit 180 of the digital camera 1 receives the list of multiple versions of correction program from the image correction apparatus 2. The liquid crystal monitor 120 of the digital camera 1 displays the list of multiple versions of correction program. The operating buttons 122 of the digital camera 1 obtain a user input for selecting one of the multiple versions of correction program. The communication unit 180 of the digital camera 1 transmits a control signal selecting one of the multiple versions of correction program, to the image correction apparatus 2.

The communication unit 304 of the image correction apparatus 2 receives the control signal selecting one of the multiple versions of correction program. The processing unit 301 of the image correction apparatus 2 corrects the image using the version of correction program selected according to the control signal.

Instead of the digital camera 1, the user terminal apparatus 7 or 8 may receive the list of multiple versions of correction program, and transmit a control signal selecting one of the multiple versions of correction program, to the image correction apparatus 2.

Using the user interface shown in FIG. 13, the user can correct the image using a desired correction program. If the user does not designate the version of correction program in advance, the latest correction programs are used for all the optical characteristics. In a case where “latest” is designated for the version of correction program, the latest correction program is always used. The user may intentionally designate an old version of correction program.

### ADVANTAGEOUS EFFECTS AND OTHERS OF FIRST EMBODIMENT

A digital camera 1 according to the first embodiment is provided with an imaging element 110 that receives light incident through an optical system including at least one lens to generate a digital image. The digital camera 1 is further provided with a communication unit 180 that communicates with an image correction apparatus 2, the image correction apparatus 2 correcting the digital image using a correction program for correcting images based on individual characteristic information indicating an optical characteristic specific to the digital camera 1. The communication unit 180 transmits the digital image generated by the imaging element 110, and identification information of the digital camera 1, to the image correction apparatus 2.

An image correction apparatus 2 according to the first embodiment is provided with: a communication unit 304, a storage unit 303, and a processing unit 301. The communication unit 304 receives a digital image captured by a digital camera 1, and identification information of the digital camera 1. The storage unit 303 stores a correction program for correcting images. The processing unit 301 obtains individual characteristic information based on the identification information, the individual characteristic information indicating an optical characteristic specific to the digital camera 1, and corrects the digital image using the correction program based on the individual characteristic information.

With such a configuration, it is possible to correct undesirable distortion, unevenness, and others in the captured image, while reducing the circuit size, cost, and/or power consumption of the digital camera 1 as compared with the prior art.

According to the first embodiment, the identification information may include at least one of a model number and a manufacturing serial number. In addition, the identification information may include an identifier associated with at least one of a model number and a manufacturing serial number.

With such a configuration, it is possible to identify an individual digital camera 1 based on the identification information, and obtain its individual characteristics information in an appropriate manner.

According to the first embodiment, the individual characteristic information may include at least one of design information of the digital camera 1, and a measurement result of an optical characteristic of the digital camera 1.

With such a configuration, it is possible to provide the optical characteristics specific to the digital camera 1 in an appropriate manner.

According to the first embodiment, the digital camera 1 may be provided with a camera body 100, and a lens apparatus 200 detachably connected to the camera body 100. In this case, the identification information includes first identification information identifying the camera body 100, and second identification information identifying the lens apparatus 200. The individual characteristic information includes first individual characteristic information indicating an optical characteristic specific to the camera body 100, and second individual characteristic information indicating an optical characteristic specific to the lens apparatus 200.

With such a configuration, it is possible to appropriately correct the image according to a combination of the camera body 100 and the lens apparatus 200.

According to the first embodiment, the camera body 100 may receive the second identification information from the lens apparatus 200 connected to the digital camera 1.

With such a configuration, the camera body 100 can provide the image correction apparatus 2 with the second identification information received from the lens apparatus 200.

According to the first embodiment, the communication unit 304 of the image correction apparatus 2 may receive the first individual characteristic information from one or more first server apparatuses 3-1 storing the first individual characteristic information on camera bodies provided by one or more camera manufacturer. The communication unit 304 of the image correction apparatus 2 may receive the second individual characteristic information from one or more second server apparatuses 3-2 to 3-3 storing the second individual characteristic information on lens apparatus 200es provided by one or more lens manufacturer.

With such a configuration, the image correction apparatus 2 can obtain appropriate individual characteristic information according to a combination of the camera body 100 and the lens apparatus 200.

According to the first embodiment, the digital camera 1 may be provided with an optical system having at least one of a variable magnification, a variable diaphragm, a variable camera-shake correction status, and a variable focus. In this case, the communication unit 180 of the digital camera 1 transmits the status information to the image correction apparatus 2, the status information indicating at least one of a magnification, a diaphragm, a camera-shake correction status, and a focus of the optical system when the imaging element 110 generates the digital image. The communication unit 304 of the image correction apparatus 2 receives status information indicating at least one of a magnification, a diaphragm, a camera-shake correction status, and a focus of the optical system when the imaging element 110 captures the digital image. The processing unit 301 of the image correction apparatus 2 corrects the digital image using the correction program based on the individual characteristic information and the status information.

With such a configuration, it is possible to appropriately correct the image according to the status of magnification, diaphragm, camera-shake correction status, and focus.

According to the first embodiment, the camera body 100 receives status information from the lens apparatus 200 connected to the camera body 100, the status information indicating at least one of a magnification, a diaphragm, a camera-shake correction status, and a focus of the optical system.

With such a configuration, the camera body 100 can provide the image correction apparatus 2 with the second status information received from the lens apparatus 200.

According to the first embodiment, the communication unit 304 of the image correction apparatus 2 may receive, from the digital camera 1, the digital image captured by the digital camera 1. The communication unit 304 of the image correction apparatus 2 may transmit the digital image corrected by the processing unit 301, to the digital camera 1. The communication unit 180 of the digital camera 1 receives, from the image correction apparatus 2, a digital image corrected by the image correction apparatus 2. The digital camera 1 is further provided with a display unit 120 that displays the digital image corrected by the image correction apparatus 2.

With such a configuration, a user of the digital camera 1 can view, on its display unit, the image corrected by the image correction apparatus 2.

According to the first embodiment, the communication unit 304 of the image correction apparatus 2 may receive an updated version of the correction program from a third server apparatus 4 storing the updated version of the correction program. In this case, the storage unit 303 of the image correction apparatus 2 stores the updated version of the correction program.

With such a configuration, the image correction apparatus 2 can provide a corrected image having improved quality using the updated version of the correction program.

According to the first embodiment, when the communication unit 304 of the image correction apparatus 2 may receive the updated version of the correction program, the communication unit 304 receives the digital image captured by the digital camera 1 from a fourth server apparatus 5 storing the digital image. The communication unit 304 of the image correction apparatus 2 may transmit the digital image corrected by the processing unit 301 of the image correction apparatus 2, to a fifth server apparatus 6.

With such a configuration, it is possible to promptly provide a corrected moving image having improved quality, for example, for an online streamer and a viewer.

According to the first embodiment, the storage unit 303 of the image correction apparatus 2 may store multiple versions of the correction program. The communication unit 180 of the digital camera 1 may receive the list of the multiple versions of the correction program from the image correction apparatus 2. In this case, the digital camera 1 is further provided with: a display unit 120 that displays a list of multiple versions of the correction program available to the image correction apparatus 2; and operating buttons 122 that obtain a user input for selecting one of the multiple versions of the correction program. The communication unit 180 of the digital camera 1 transmits a control signal to the image correction apparatus 2, the control signal selecting one of the multiple versions of the correction program. The communication unit 304 of the image correction apparatus 2 receives the control signal selecting one of the multiple versions of the correction program. The processing unit 301 of the image correction apparatus 2 corrects the digital image using a version of the correction program selected according to the control signal.

With such a configuration, the user can correct the image using a desired correction program.

According to the first embodiment, the imaging element 110 of the digital camera 1 may receive light incident through the optical system to generate a digital moving image. In this case, the communication unit 180 of the digital camera 1 transmits the digital moving image generated by the imaging element 110, and the identification information of the digital camera 1, to the image correction apparatus 2. The communication unit 304 of the image correction apparatus 2 receives a digital moving image captured by the digital camera 1. The processing unit 301 of the image correction apparatus 2 corrects the digital moving image using the correction program.

With such a configuration, for example, it is possible to correct and display the captured data in real time to present the corrected preview image in real time.

### Second Embodiment

The correction process according to the embodiment is applicable not only to the image captured by the digital camera 1 provided with the camera body 100, and the lens apparatus 200 detachably connected to the camera body 100, but also to an image captured by an integrated digital camera. In the following, a second embodiment of the present disclosure will be described.

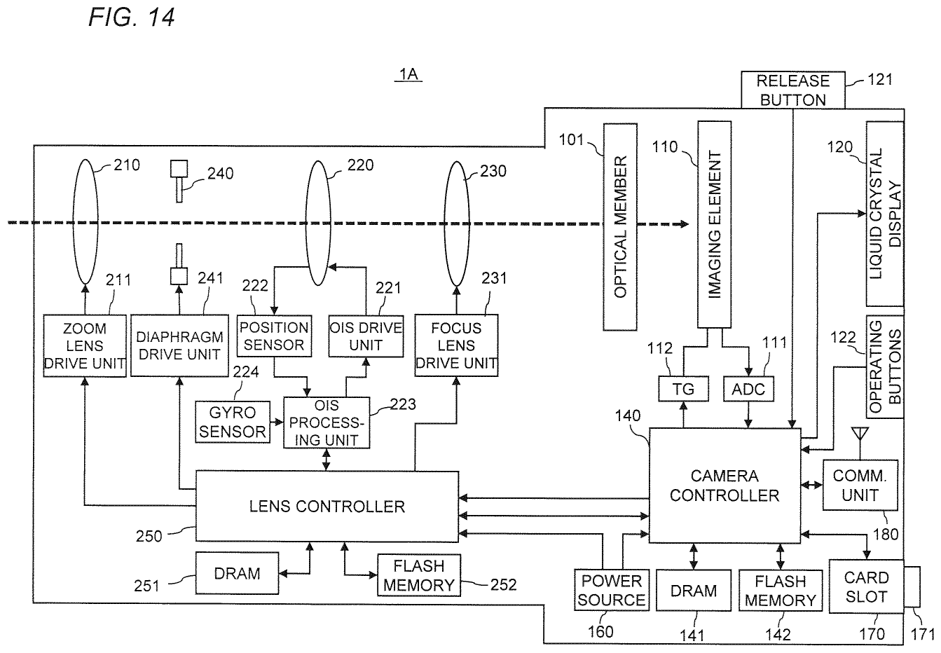

FIG. 14 is a block diagram showing a configuration of a digital camera 1A according to the second embodiment. The digital camera 1A is provided with the components of the camera body 100 and the lens apparatus 200 of FIG. 2, except for the body mount 150 and the lens mount 260. The camera controller 140, the power supply 160, and the lens controller 250 are directly connected to each other, without through the body mount 150 and the lens mount 260. The flash memory 142 stores identification information of the digital camera 1A, instead of the identification information of the camera body 100. The flash memory 252 stores a firmware program of the lens apparatus 200, user settings, and others. The lens controller 250, DRAM 251, and flash memory 252 may be integrated with the corresponding camera controller 140, DRAM 141, and flash memory 142.

The digital camera 1A is an example of an imaging apparatus.

The digital camera 1A is wirelessly connected to an access point apparatus, and is connected to the communication line 11 through the access point apparatus, in a manner similar to that of the digital camera 1 of FIG. 1. In addition, the image correction system according to the second embodiment includes a server apparatus that stores individual characteristic information indicating optical characteristics specific to the digital camera 1A. The image correction apparatus 2 receives the individual characteristic information of the digital camera 1A from the server apparatus through the communication line 11. The image correction apparatus 2 corrects the image received from the digital camera 1A, using a correction program for correcting images based on the individual characteristic information indicating the optical characteristics specific to the digital camera 1A. The image correction apparatus 2 transmits the corrected image to the digital camera 1A through the communication line 11 and the access point apparatus.

According to the second embodiment, it is possible to correct undesirable distortion, unevenness, and others in a captured image, while reducing the circuit size, cost, and/or power consumption of the digital camera 1A as compared with the prior art, in a manner similar to that of the first embodiment.

### ADVANTAGEOUS EFFECTS AND OTHERS OF SECOND EMBODIMENT

A digital camera 1A according to the second embodiment is provided with an imaging element 110 that receives light incident through an optical system including at least one lens to generate a digital image. The digital camera 1A is further provided with a communication unit 180 that communicates with an image correction apparatus 2, the image correction apparatus 2 correcting the digital image using a correction program for correcting images based on individual characteristic information indicating an optical characteristic specific to the digital camera 1A. The communication unit 180 transmits the digital image generated by the imaging element 110, and identification information of the digital camera 1A, to the image correction apparatus 2.

With such a configuration, it is possible to correct undesirable distortion, unevenness, and others in the captured image, while reducing the circuit size, cost, and/or power consumption of the digital camera 1A as compared with the prior art.

According to the second embodiment, the digital camera 1A is further provided with the optical system including the at least one lens.

With such a configuration, it is possible to correct undesirable distortion, unevenness, and others in the image captured by an integrated digital camera.

According to the second embodiment, the optical system may have at least one of a variable magnification, a variable diaphragm, a variable camera-shake correction status, and a variable focus. In this case, the communication unit 180 transmits status information to the image correction apparatus 2, the status information indicating at least one of a magnification, a diaphragm, a camera-shake correction status, and a focus of the optical system when the imaging element 110 generates the digital image. The image correction apparatus 2 corrects the digital image using the correction program based on the individual characteristic information and the status information.

With such a configuration, it is possible to appropriately correct the image according to the status of magnification, diaphragm, camera-shake correction status, and focus.

### OTHER EMBODIMENTS

As described above, the embodiments have been described as examples of the technology disclosed in the present application. However, the technology in the present disclosure is not limited thereto, and is applicable to embodiments with some changes, replacements, additions, omissions, and the like. In addition, new embodiments can be derived by combining the constituent elements described in the aforementioned embodiments.

In a case where the optical system of the camera body 100 has a variable status, the image correction apparatus 2 may correct the image using the correction program based on not only the status information of the lens apparatus 200, but also the status information of the camera body 100.

The image correction apparatus 2 may receive the individual characteristic information from not only the one server apparatus 3-1, but also a plurality of server apparatuses storing individual characteristic information of the camera bodies 100 provided by a plurality of camera manufacturers.

The image correction apparatus may obtain the contents of the server apparatuses 3-1 to 3-3 in advance and store the contents in the storage unit 303, instead of inquiring of the server apparatuses 3-1 to 3-3 after receiving the captured image from the digital camera 1 as shown in FIG. 10.

The digital camera 1 may display the captured image (that is, uncorrected image) on the liquid crystal monitor 120, and displays the corrected image on an external monitor connected to the digital camera 1.

The individual characteristic information of the digital camera 1 is not limited to the sensor luminance unevenness, the sensor color unevenness, the decrease in peripheral illumination, the decrease in resolution, the optical chromatic aberration, and the optical distortion. The individual characteristic information of the digital camera 1 may include, for example, optical characteristics related to focusing of the lens apparatus 200, image quality enhancement of a signal processing circuit of the camera body 100, and others.

The imaging apparatus according to the embodiment may be the digital camera 1 provided with the camera body 100, and the lens apparatus 200 detachably connected to the camera body 100. In addition, the imaging apparatus according to the embodiment may be the camera body 100 detachably connected to the lens apparatus 200 provided with the optical system including at least one lens. In addition, the imaging apparatus according to the embodiment may be the digital camera 1A provided with the optical system including at least one lens. In any case, “identification information of imaging apparatus” means information to be transmitted from the imaging apparatus to the image correction apparatus 2, by which the image correction apparatus 2 can identify an apparatus involved in capturing a digital image. Therefore, the identification information of the imaging apparatus may be a combination of the identification information of the camera body 100 and the identification information of the lens apparatus 200 (first embodiment), or may be the identification information of the digital camera 1A (second embodiment). In addition, “individual characteristic information of imaging apparatus” means the optical characteristics of an apparatus involved in capturing a digital image. Therefore, the identification information of the imaging apparatus may be a combination of the individual characteristic information of the camera body 100 and the individual characteristic information of the lens apparatus 200 (first embodiment), or may be the individual characteristic information of the digital camera 1A (second embodiment).

As described above, the embodiments have been described as examples of the technology according to the present disclosure. The accompanying drawings and the detailed description have been provided for this purpose.

Accordingly, the constituent elements described in the accompanying drawings and the detailed description may include not only constituent elements essential to solving the problem, but also constituent elements not essential to solving the problem, in order to exemplify the technology. Therefore, even when those non-essential constituent elements are described in the accompanying drawings and the detailed description, those non-essential constituent elements should not be considered essentials.

In addition, since the above-described embodiments are intended to exemplify the technology of the present disclosure, it is possible to make various changes, replacements, additions, omissions, and the like within the scope of claims or the equivalent thereof.

### SUMMARY OF EMBODIMENTS

The digital camera, the image correction apparatus, and the image correction system according to the embodiments may be expressed as follows.

An image correction apparatus according to a first aspect of the present disclosure is provided with: a communication unit, a storage unit, and a processing unit. The communication unit receives a digital image captured by an imaging apparatus, and identification information of the imaging apparatus. The storage unit stores a correction program for correcting images. The processing unit obtains individual characteristic information based on the identification information, the individual characteristic information indicating an optical characteristic specific to the imaging apparatus, and corrects the digital image using the correction program based on the individual characteristic information.

According to a mage correction apparatus of a second aspect of the present disclosure, the image correction apparatus of the first aspect is further configured as follows. The identification information includes at least one of a model number and a manufacturing serial number.

According to a mage correction apparatus of a third aspect of the present disclosure, the image correction apparatus of the first aspect is further configured as follows. The identification information includes an identifier associated with at least one of a model number and a manufacturing serial number.

According to a mage correction apparatus of a fourth aspect of the present disclosure, the image correction apparatus of one of the first to third aspects is further configured as follows. The individual characteristic information includes at least one of design information of the imaging apparatus, and a measurement result of an optical characteristic of the imaging apparatus.

According to a mage correction apparatus of a fifth aspect of the present disclosure, the image correction apparatus of one of the first to fourth aspects is further configured as follows. The imaging apparatus is provided with a camera body, and a lens apparatus detachably connected to the camera body. The identification information includes first identification information identifying the camera body, and second identification information identifying the lens apparatus. The individual characteristic information includes first individual characteristic information indicating an optical characteristic specific to the camera body, and second individual characteristic information indicating an optical characteristic specific to the lens apparatus,

According to a mage correction apparatus of a sixth aspect of the present disclosure, the image correction apparatus of the fifth aspect is further configured as follows. The communication unit receives the first individual characteristic information from one or more first server apparatuses storing the first individual characteristic information on camera bodies provided by one or more camera manufacturer. The communication unit receives the second individual characteristic information from one or more second server apparatuses storing the second individual characteristic information on lens apparatuses provided by one or more lens manufacturer.

According to a mage correction apparatus of a seventh aspect of the present disclosure, the image correction apparatus of one of the first to sixth aspects is further configured as follows. The imaging apparatus is provided with an optical system having at least one of a variable magnification, a variable diaphragm, a variable camera-shake correction status, and a variable focus. The communication unit receives status information indicating at least one of a magnification, a diaphragm, a camera-shake correction status, and a focus of the optical system when the imaging element captures the digital image. The processing unit corrects the digital image using the correction program based on the individual characteristic information and the status information.

According to a mage correction apparatus of an eighth aspect of the present disclosure, the image correction apparatus of one of the first to seventh aspects is further configured as follows. The communication unit receives, from the imaging apparatus, the digital image captured by the imaging apparatus. The communication unit transmits the digital image corrected by the processing unit, to the imaging apparatus.

According to a mage correction apparatus of a ninth aspect of the present disclosure, the image correction apparatus of one of the first to eighth aspects is further configured as follows. The communication unit receives an updated version of the correction program from a third server apparatus storing the updated version of the correction program. The storage unit stores the updated version of the correction program.

According to a mage correction apparatus of a tenth aspect of the present disclosure, the image correction apparatus of the ninth aspect is further configured as follows. When the communication unit receives the updated version of the correction program, the communication unit receives the digital image captured by the imaging apparatus from a fourth server apparatus storing the digital image, and transmits the digital image corrected by the processing unit, to a fifth server apparatus.

According to a mage correction apparatus of a 11th aspect of the present disclosure, the image correction apparatus of the ninth or tenth aspect is further configured as follows. The storage unit stores multiple versions of the correction program. The communication unit receives a control signal selecting one of the multiple versions of the correction program. The processing unit corrects the digital image using a version of the correction program selected according to the control signal.

According to a mage correction apparatus of a 12th aspect of the present disclosure, the image correction apparatus of one of the first to 11th aspects is further configured as follows. The communication unit receives a digital moving image captured by the imaging apparatus. The processing unit corrects the digital moving image using the correction program.

A mage correction system according to a 13th aspect of the present disclosure is provided with: an imaging apparatus; and the image correction apparatus of one of the first to 12th aspects.

A mage correction method according to a 14th aspect of the present disclosure includes receiving a digital image captured by an imaging apparatus, and identification information of the imaging apparatus. The method further includes reading, from a storage unit, a correction program for correcting images. The method further includes obtaining individual characteristic information based on the identification information, the individual characteristic information indicating an optical characteristic specific to the imaging apparatus. The method further includes correcting the digital image using the correction program based on the individual characteristic information.

A program according to a 15th aspect of the present disclosure includes instructions executed by a processing circuit of a computing apparatus. The instruction causes the processing circuit to receive digital image captured by an imaging apparatus, and identification information of the imaging apparatus. The instruction causes the processing circuit to read, from a storage unit, a correction program for correcting images. The instruction causes the processing circuit to obtain individual characteristic information based on the identification information, the individual characteristic information indicating an optical characteristic specific to the imaging apparatus. The instruction causes the processing circuit to correct the digital image using the correction program based on the individual characteristic information.

An imaging apparatus according to a 16th aspect of the present disclosure is provided with an imaging element that receives light incident through an optical system including at least one lens to generate a digital image. The imaging apparatus is further provided with a communication unit that communicates with an image correction apparatus, the image correction apparatus correcting the digital image using a correction program for correcting images based on individual characteristic information indicating an optical characteristic specific to the imaging apparatus. The communication unit transmits the digital image generated by the imaging element, and identification information of the imaging apparatus, to the image correction apparatus.

According to an imaging apparatus of a 17th aspect of the present disclosure, the imaging apparatus of the 16th aspect is further configured as follows. The identification information includes at least one of a model number and a manufacturing serial number.

According to an imaging apparatus of a 18th aspect of the present disclosure, the imaging apparatus of the 16th aspect is further configured as follows. The identification information includes an identifier associated with at least one of a model number and a manufacturing serial number.

According to an imaging apparatus of a 19th aspect of the present disclosure, the imaging apparatus of one of the 16th to 18th aspects is further configured as follows. The individual characteristic information includes at least one of design information of the imaging apparatus, and a measurement result of an optical characteristic of the imaging apparatus.

According to an imaging apparatus of a 20th aspect of the present disclosure, the imaging apparatus of one of the 16th to 19th aspects is further configured as follows. The imaging apparatus is a camera body detachably connected to a lens apparatus provided with the optical system including the at least one lens. The identification information includes first identification information identifying the camera body, and second identification information identifying the lens apparatus. The individual characteristic information includes first individual characteristic information indicating an optical characteristic specific to the camera body, and second individual characteristic information indicating an optical characteristic specific to the lens apparatus.

According to an imaging apparatus of a 21st aspect of the present disclosure, the imaging apparatus of the 20th aspect is further configured as follows. The imaging apparatus receives the second identification information from the lens apparatus connected to the imaging apparatus.

According to an imaging apparatus of a 22nd aspect of the present disclosure, the imaging apparatus of the 20th or 21st aspect is further configured as follows. The optical system has at least one of a variable magnification, a variable diaphragm, a variable camera-shake correction status, and a variable focus. The imaging apparatus receives status information from the lens apparatus connected to the imaging apparatus, the status information indicating at least one of a magnification, a diaphragm, a camera-shake correction status, and a focus of the optical system. The communication unit transmits the status information to the image correction apparatus, the status information indicating at least one of a magnification, a diaphragm, a camera-shake correction status, and a focus of the optical system when the imaging element generates the digital image. The image correction apparatus corrects the digital image using the correction program based on the individual characteristic information and the status information.

According to an imaging apparatus of a 23rd aspect of the present disclosure, the imaging apparatus of one of the 16th to 19th aspects is further configured as follows. The imaging apparatus is further provided with the optical system including the at least one lens.

According to an imaging apparatus of a 24th aspect of the present disclosure, the imaging apparatus of the 23rd aspect is further configured as follows. The optical system has at least one of a variable magnification, a variable diaphragm, a variable camera-shake correction status, and a variable focus. The communication unit transmits status information to the image correction apparatus, the status information indicating at least one of a magnification, a diaphragm, a camera-shake correction status, and a focus of the optical system when the imaging element generates the digital image. The image correction apparatus corrects the digital image using the correction program based on the individual characteristic information and the status information.

According to an imaging apparatus of a 25th aspect of the present disclosure, the imaging apparatus of one of the 16th to 24th aspects is further configured as follows. The communication unit receives, from the image correction apparatus, a digital image corrected by the image correction apparatus. The imaging apparatus is further provided with a display unit that displays the digital image corrected by the image correction apparatus.

According to an imaging apparatus of a 26th aspect of the present disclosure, the imaging apparatus of one of the 16th to 25th aspects is further configured as follows. The imaging apparatus is further provided with: a display unit that displays a list of multiple versions of the correction program available to the image correction apparatus; and an input unit that obtains a user input for selecting one of the multiple versions of the correction program. The communication unit receives the list of the multiple versions of the correction program from the image correction apparatus; and transmits a control signal to the image correction apparatus, the control signal selecting one of the multiple versions of the correction program.

According to an imaging apparatus of a 27th aspect of the present disclosure, the imaging apparatus of one of the 16th to 26th aspects is further configured as follows. The imaging element receives light incident through the optical system to generate a digital moving image. The communication unit transmits the digital moving image generated by the imaging element, and the identification information of the imaging apparatus, to the image correction apparatus.

An imaging method according to a 28th aspect of the present disclosure is for an imaging apparatus provided with an imaging element that receives light incident through an optical system including at least one lens to generate a digital image. The imaging method includes communicating with an image correction apparatus, the image correction apparatus correcting the digital image using a correction program for correcting images based on individual characteristic information indicating an optical characteristic specific to the imaging apparatus. The communicating includes transmitting the digital image generated by the imaging element, and identification information of the imaging apparatus, to the image correction apparatus.

A program according to a 29th aspect of the present disclosure includes instructions executed by a processing circuit of an imaging apparatus. The instruction causes the processing circuit to execute communicating with an image correction apparatus, the image correction apparatus correcting the digital image using a correction program for correcting images based on individual characteristic information indicating an optical characteristic specific to the imaging apparatus. The communicating includes transmitting the digital image generated by the imaging element, and identification information of the imaging apparatus, to the image correction apparatus.

### INDUSTRIAL APPLICABILITY

The present disclosure is applicable to a digital camera that generates a still image or a moving image.

### REFERENCE SIGNS LIST

1,1A: digital camera
2: image correction apparatus
3-1: server apparatus (individual characteristics of camera body)
3-2: server apparatus (individual characteristics of lens apparatus)
3-3: server apparatus (individual characteristics of lens apparatus)
4: server apparatus (updated versions of correction program)
5: server apparatus (captured images)
6: server apparatus (corrected images)
7, 8: user terminal apparatus
11: communication line
12-1 to 12-3: access point apparatus (AP)
20: image correction system
100: camera body
100A: measuring camera body
110: imaging element
111: analog/digital converter (ADC)
112: timing generator (TG)
120: liquid crystal monitor
121: release button
122: operating buttons
140: camera controller
141: DRAM
142: flash memory
150: body mount
160: power supply
170: card slot
171: memory card
180: communication unit
200: lens apparatus
200A: measuring lens apparatus
210: zoom lens
211: zoom lens drive unit
220: optical image stabilizer (OIS) lens
221: OIS drive unit
222: position sensor
223: OIS processing unit
224: gyro sensor
230: focus lens
231: focus lens drive unit
240: diaphragm device
241: diaphragm drive unit
250: lens controller
251: DRAM
252: flash memory
260: lens mount
300: bus
301: processing unit
302: memory
303: storage unit
304: communication unit
400; bus
401: processing unit
402: memory
403: storage unit
404: communication unit
500: bus
501: processing unit
502: memory
503: storage unit
504: communication unit
505: input unit
506: display unit
601, 602: control apparatus
610: light source panel

1. An imaging apparatus comprising an imaging element that receives light incident through an optical system including at least one lens to generate a digital image,
wherein the imaging apparatus further comprises:
a communication unit that communicates with an image correction apparatus, the image correction apparatus correcting the digital image using a correction program for correcting images based on individual characteristic information indicating an optical characteristic specific to the imaging apparatus;
a display unit that displays a list of multiple versions of the correction program available to the image correction apparatus; and
an input unit that obtains a user input for selecting one of the multiple versions of the correction program,
wherein the communication unit transmits the digital image generated by the imaging element, and identification information of the imaging apparatus, to the image correction apparatus, and
wherein the communication unit receives the list of the multiple versions of the correction program from the image correction apparatus; and transmits a control signal to the image correction apparatus, the control signal selecting one of the multiple versions of the correction program.

2. The imaging apparatus as claimed in claim 1,
wherein the identification information includes at least one of a model number and a manufacturing serial number.

3. The imaging apparatus as claimed in claim 1,
wherein the identification information includes an identifier associated with at least one of a model number and a manufacturing serial number.

4. The imaging apparatus as claimed in claim 1,
wherein the individual characteristic information includes at least one of design information of the imaging apparatus, and a measurement result of an optical characteristic of the imaging apparatus.

5. The imaging apparatus as claimed in claim 1,
wherein the imaging apparatus is a camera body detachably connected to a lens apparatus comprising the optical system including the at least one lens,
wherein the identification information includes first identification information identifying the camera body, and second identification information identifying the lens apparatus, and
wherein the individual characteristic information includes first individual characteristic information indicating an optical characteristic specific to the camera body, and second individual characteristic information indicating an optical characteristic specific to the lens apparatus.

6. The imaging apparatus as claimed in claim 5,
wherein the imaging apparatus receives the second identification information from the lens apparatus connected to the imaging apparatus.

7. The imaging apparatus as claimed in claim 5,
wherein the optical system has at least one of a variable magnification, a variable diaphragm, a variable camera-shake correction status, and a variable focus,
wherein the imaging apparatus receives status information from the lens apparatus connected to the imaging apparatus, the status information indicating at least one of a magnification, a diaphragm, a camera-shake correction status, and a focus of the optical system,
wherein the communication unit transmits the status information to the image correction apparatus, the status information indicating at least one of a magnification, a diaphragm, a camera-shake correction status, and a focus of the optical system when the imaging element generates the digital image, and
wherein the image correction apparatus corrects the digital image using the correction program based on the individual characteristic information and the status information.

8. The imaging apparatus as claimed in claim 1,
wherein the imaging apparatus further comprises the optical system including the at least one lens.

9. The imaging apparatus as claimed in claim 8,
wherein the optical system has at least one of a variable magnification, a variable diaphragm, a variable camera-shake correction status, and a variable focus,
wherein the communication unit transmits status information to the image correction apparatus, the status information indicating at least one of a magnification, a diaphragm, a camera-shake correction status, and a focus of the optical system when the imaging element generates the digital image, and
wherein the image correction apparatus corrects the digital image using the correction program based on the individual characteristic information and the status information.

10. The imaging apparatus as claimed in claim 1,
wherein the communication unit receives, from the image correction apparatus, a digital image corrected by the image correction apparatus, and
wherein the imaging apparatus further comprises a display unit that displays the digital image corrected by the image correction apparatus.

11. (canceled)

12. The imaging apparatus as claimed in claim 1,
wherein the imaging element receives light incident through the optical system to generate a digital moving image, and
wherein the communication unit transmits the digital moving image generated by the imaging element, and the identification information of the imaging apparatus, to the image correction apparatus.

13. An imaging method of an imaging apparatus comprising an imaging element that receives light incident through an optical system including at least one lens to generate a digital image, the imaging method including:
communicating with an image correction apparatus, the image correction apparatus correcting the digital image using a correction program for correcting images based on individual characteristic information indicating an optical characteristic specific to the imaging apparatus,
displaying a list of multiple versions of the correction program available to the image correction apparatus; and
obtaining a user input for selecting one of the multiple versions of the correction program,
wherein the communicating includes transmitting the digital image generated by the imaging element, and identification information of the imaging apparatus, to the image correction apparatus, and
wherein the communicating further includes:
receiving the list of the multiple versions of the correction program from the image correction apparatus; and
transmitting a control signal to the image correction apparatus, the control signal selecting one of the multiple versions of the correction program.

14. (canceled)

15. The imaging apparatus as claimed in claim 1,
wherein the image correction apparatus transmits the digital image or the corrected digital image to a user terminal different from the imaging apparatus.
